(19) United States
(12) Patent Application Publication
(10) Pub. No.: US 2026/0212800 A1
(43) Pub. Date: Jul. 23, 2026

(54) SYSTEM AND METHOD FOR ON-THE-FLY SWITCHING RESOLUTION MODES WITHIN A DUAL RESOLUTION VIDEO DISPLAY DEVICE

(71) Applicant: Dell Products LP, Round Rock, TX (US)

(72) Inventors: Lei Guo, Singapore (SG); Eng Cheng Vincent Yap, Singapore (SG); Boon Heng Koh, Singapore (SG)

(73) Assignee: Dell Products LP, Round Rock, TX (US)

(21) Appl. No.: 19/032,980

(22) Filed: Jan. 21, 2025

(51) Int. Cl. G09G 3/20; G06F 3/147

(52) U.S. Cl. CPC G09G 3/2096; G06F 3/147; G09G 2320/0252; G09G 2320/0257; G09G 2320/0613; G09G 2340/0435; G09G 2354/00; G09G 2370/042; G09G 2370/16

(57) ABSTRACT

A system and method comprising a video display device including an image and video scaler hardware controller, a nonvolatile storage device, and a power supply unit to provide power to the video scaler and nonvolatile storage device. The image and video scaler hardware controller to receive input from an information handling system indicating an on-the-fly signal timing change in received video data during ongoing execution of software applications and to determine to switch image and video output at the video display device from a first frame rate and resolution mode to a second frame rate and resolution mode based on determined resolution and frame rate of incoming video data, and access a plural mode extended display identification data (EDID) within an EDID memory at the video display device to resize and adjust the resolution and frame rate at the display panel according to the second frame rate and resolution mode.

### FIELD OF THE DISCLOSURE

The present disclosure generally relates to execution of computer-readable program code instructions of an image and video scaler hardware controller to switch between resolution and frame rate modes. The present disclosure more specifically relates systems and methods for executing computer-readable program code instructions for on-the-fly switching resolution modes within a plural resolution video display device, such as a dual resolution video display device, to switch between a first frame rate and resolution mode to a second frame rate and resolution mode during ongoing execution of software applications such as gaming applications.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions with a graphics processing unit for presentation of graphics on a video display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a video display device including an image and video scaler hardware controller to execute computer-readable program code instructions of a mode switch judgment firmware module to switch from a first frame rate and resolution mode to a second frame rate and resolution mode on-the-fly during software application execution according to an embodiment of the present disclosure;

FIG. 2 is a graphic and block illustrating an information handling system operatively coupled to a video display device including an image and video scaler hardware controller to execute computer-readable program code instructions of a mode switch judgment firmware module to switch on-the-fly from a first frame rate and resolution mode to a second frame rate and resolution mode according to another embodiment of the present disclosure; and

FIG. 3 is a flow diagram showing a method executing computer-readable program code instructions for on-the-fly switching resolution modes within a plural resolution video display device according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may include any number of a plurality of input and output devices that allow a user to interact with the information handling system. Among the output devices includes a video display device. These video display devices may include both wired and wireless video display devices and may be one of potentially many video display devices used by the user to receive output from the user. Additionally, these video display devices may present to a user various graphical user interfaces, images, graphics, and videos commensurate with the output from the information handling system and execution of one or more software applications thereon. For example, gaming software applications may execute to present gaming graphics to a user. In some examples, these video display devices may include a display panel that is capable of toggling between two or more different resolution and frame rate modes. In order to toggle between these two or more different resolution and frame rate modes, a button or other input device at the video display device may be provided such that a user may actuate that button or input device to toggle between the two different resolution and frame rate modes.

Toggling between the two or more different resolution and frame rate modes using this button or other input device, however, may cause a plurality of issues to arise including distortion and/or delay as the resolution and frame rate adjusts. For example, changes in extended display identification data (EDID) used while in a full screen application that uses, for example, Microsoft® DirectX® application programming interfaces (APIs) for gaming applications may result in the displayed images and video being enlarged or otherwise distorted. This specific issue does not occur at the operating system (OS) level, but instead occurs at the software application level such as when a gaming application is executed. This is because the gaming application or other such software applications will only request and read the EDID once during execution such that the original frame rates and resolutions defined by the EDID are maintained throughout the execution duration of the gaming application. Changes in frame rate and resolution require coordination of the EDID used at the information handling system by the software application and that provided to and used at the video display device. Such as coordination may not occur when a software application, such as a gaming application, has ongoing for a duration before the updated EDID is accessed, or it may require several steps including delay and interruption of the ongoing software application. Thus, where a user actuates the button or other input device at the video display device during execution of the gaming application or other application, the change in EDID inputs to be used at the video display device may result in the distortion in the output at the video display device from video graphics data received from the ongoing application of the software application. For example, the new settings and controls of a replacement EDID at the video display device will not take effect in the video data from a gaming software application until the gaming application duration has finished. In order to overcome this issue, the user must stop the execution of the application (e.g., the gaming application) actuate the button or other input device to toggle to the different resolution and frame rate mode, and then cause the software application to be executed again.

Yet another issue that arises with the use of the toggling button or other input device at the video display device includes long mode switching times. Here, actuation of the button or other input device at the video display device initiates a process for the EDID change that will invoke hot-plug-detection (HPD), link training, high-bandwidth digital content protection (HDCP), and the like, such that the video displayed on the video display device is muted for a significant time resulting in a blank screen. Again, in the example where the application being executed is a gaming application such as first-person gaming application, this blank screen and delay can be dissatisfying to a user. For example, such a delay can significantly affect play of a gaming application.

To address these and other issues, the present specification describes a video display device that includes an image and video scaler hardware controller, a nonvolatile storage device for storage of a plural mode EDID, a timing controller (TCON), a display panel, and a power supply unit (PSU) to provide power to the video scaler, nonvolatile storage device, TCON and display panel. The video and image video scaler hardware controller of the video display device may receive video data input from an information handling system that switches image and video output at the video display device from a first frame rate and resolution mode to a second frame rate and resolution mode. In an embodiment, the image and video scaler hardware controller may execute computer-readable program code of a mode switch judgment firmware module to detect the video data input, including signal timing change, from the information handling system to switch from the first frame rate and resolution mode to the second frame rate and resolution mode. This video data input may be received on-the-fly from an ongoing execution of a software application, such as a gaming application, that has set the EDID, or an plural mode EDID in embodiments herein, used for a frame rate and resolution levels upon commencement of execution and provide ongoing graphics video data during execution. The image and video scaler hardware controller may also execute the computer-readable program code of the mode switch judgment firmware module to detect a change in signal timing of the video input for when a frame rate and resolution selection has been changed during ongoing execution of the software application. Upon determination of a signal timing change, the image and video scaler hardware controller may also execute the computer-readable program code of the mode switch judgment firmware module will access a plural mode extended display identification data (EDID) within a non-volatile EDID memory of the non-volatile storage device and resize and adjust the resolution and frame rate on-the-fly according to the second frame rate and resolution mode also found within the plural mode EDID. This results in, at least, an on-the-fly change in the resolution and frame rate during ongoing execution of the software application with those issues of distortion or delay mentioned herein being alleviated or limited thereby increasing productivity at the information handling system.

In an embodiment, the input from an information handling system to switch image and video output at the video display device, via a selection by a user at the software application settings or operating system settings at the information handling system, may be received at the video display device as a change in signal timing. This change in signal timing may trigger a change from a first frame rate and resolution mode to a second frame rate and resolution mode at the video display device according to embodiments herein. For example, a user activation that is indicated in change of signal rate of the incoming video data is completed at the video display device. The user activation for the change in frame rate or resolution may be received via application settings during execution of the ongoing software application. In such an embodiment, a resulting change in video data signal rate may trigger a change in frame rate and resolution among plural mode without the video display device having to coordinate an updated EDID with the information handling system. Such a coordination of updating EDID between the video display device and the information handling system may otherwise be blocked by the ongoing software application which may be limited to checking the EDID at commencement of execution. In another example embodiment, the input from an information handling system to switch image and video output at the video display device from a first frame rate and resolution mode to a second frame rate and resolution mode includes user activation that is completed during execution of an application at the video display device via OS display settings.

In an embodiment, the image and video scaler hardware controller may execute the computer-readable program code instructions of the mode switch judgment firmware module to direct a timing controller (TCON) of a display panel to switch from the first frame rate and resolution mode to the second frame rate and resolution mode based on the resizing and adjustment of the resolution and frame rate according to the second frame rate and resolution mode. Both options of the first frame rate and resolution mode and the second frame rate and resolution mode are provided for in the plural mode EDID stored at the non-volatile memory of the video display device and accessible to the image and video scaler hardware controller hardware processor. It is appreciated that while the current embodiments discuss two frame rate and resolution modes, more than two frame rates and resolution modes may be made available in the plural mode EDID in other embodiments. In an embodiment, the TCON may mute the video prior to switching from the first frame rate and resolution mode to the second frame rate and resolution mode and unmute the video after the TCON switches from the first frame rate and resolution mode the second frame rate and resolution mode. During operation, the TCON may calculate a frame rate and resolution for the second frame rate and resolution mode based on the resizing and adjustments of the resolution and frame rate found in another mode from the plural mode EDID, and provide the image and video output to a display of the video display device at the resized and adjusted resolution. The image and video output to the display of the video display device is resized and has adjusted resolution according to the second frame rate and resolution mode from the plural mode EDID without distortion, with reduced delay, and with limited interruption to the ongoing execution of the software application such as the gaming application in embodiments herein.

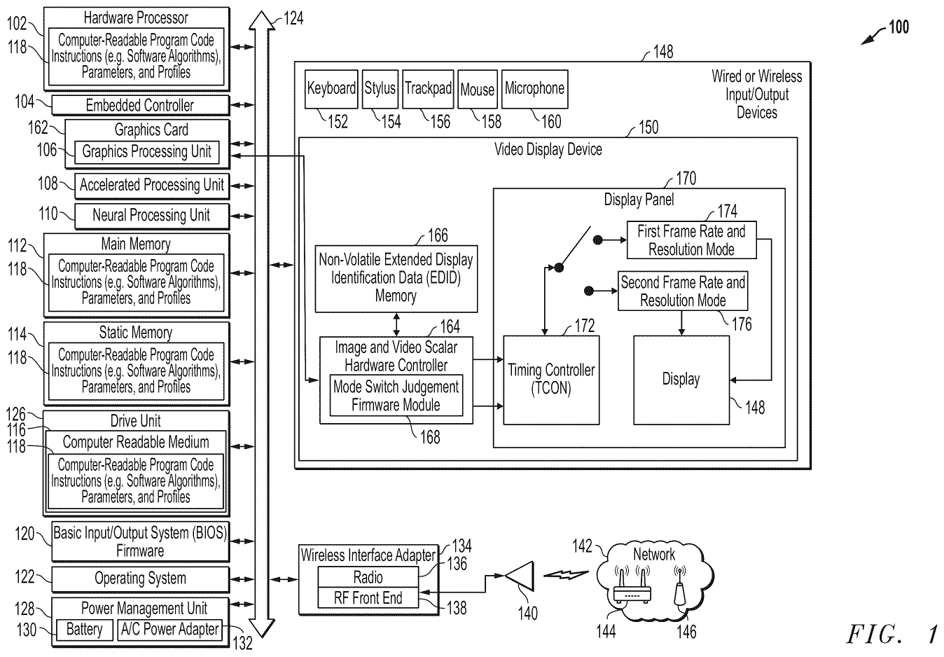

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a video display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, video display device 150, stylus 154, trackpad 156, microphone 160, among other peripheral devices.

As described herein, the information handling system 100 further includes a video display device 150. The video display device 150 in an embodiment may function as a liquid crystal display (LCD), an organic light emitting diode (OLED), a flat panel display, or a solid-state display. It is appreciated that the video display device 150 may be wired or wireless and may be an external video display device 150 that allows a user to increase the desktop area by extending the desktop in an embodiment. In embodiments herein, the video display device 150 may include display panel 178 with a display panel control board 170 including a timing controller (TCON) 172 that is a hardware controller for operation of the display panel 178. Further, the video display device 150 may include an image and video scaler hardware controller 164, also referred to as an image and video scaler, with access to a non-volatile memory such as non-volatile extended display identification data (EDID) memory 166 for various operations of receiving and processing video data for display at the display panel 178 as well as managing other functions of the video display device 150. For example, the video display device 150 may include other features and operational capabilities, such as a webcam, audio, microphone, power systems, and other functionality.

Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148, including a video display device 150 of embodiments herein, may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a video display device 150. The video display device 150 may be operatively coupled to the information handling system 100 via a wired connection such as a universal serial bus (USB) cable via a port such as a USB port formed into the information handling system 100. Additionally, or alternatively, the video display device 150 may include an external video display device 150 that is operatively coupled to the information handling system 100 via a wireless connection using the wireless interface device 134 and appropriate wireless protocols described herein.

In order to interface with the video display device 150, the information handling system 100 includes a GPU 106 formed on a graphics card 162 that transmits image, video, graphical, and graphical user interface (GUI) data to the video display device 150. The GPU 106 may be any hardware processing device that accelerates graphics rendering tasks such as rendering images, videos, and animations via an image and video scaler hardware controller 154 and TCON 172 for representation on the display 178 of the video display device 150. It is appreciated, however, that any hardware processing device such as the hardware processor 102 (e.g., CPU), the EC 104, the APU 108, or the NPU 110 may also be used in tandem with or without the GPU 106 or an image and video scaler hardware controller 154 and TCON 172 to render the images, videos, and animations for representation on the display 178 at video display device 150.

The video display device 150 may include an image and video scaler hardware controller 164 that receives the image and video data output from the information handling system 100. The image and video scaler hardware controller 164 may be any hardware processor device, such as a controller, that is used to control rendering frame rate, resolution, contrast, color schemes, and other factors of operation of a display 178 on a display panel 170 via the TCON 172. The image and video scaler hardware controller 164 may adjust the resolution of image and video signals by scaling them up or down to match, in the present embodiments, one of a plurality of available native resolutions and frame rates available at the video display device 150. The EDID sets a coordination between the operation of an ongoing software applications at the information handling system generating graphics as video data with the display of that video data via the image and video scaler hardware controller 164 and TCON 172 at display panel 170. In embodiments herein, a plural mode extended display identification data (EDID) is used setting forth settings or capabilities available for the video display device 150 and stored locally at the non-volatile EDID memory 166. Thus, while the video data for graphics are generated by the GPU 106 during execution of one or more computer readable program code instructions 118 for software applications, such as gaming applications, the video display device 150 may change resolution and frame rate of the display of that video data on-the-fly without resetting the EDID between the video display device and the information handling system and avoid distortion and minimize delay during the change.

In an embodiment, the video display device 150 may be capable of presenting images and video at, at least, two different frame rate and resolution modes. In an example embodiment, a first frame rate and resolution mode 174 may be an ultra-high definition (UHD) having a resolution of 3840 by 2160 pixels and a refresh rate of 240 hertz (Hz). In this example embodiment, the second frame rate and resolution mode 176 may be a full high definition (FHD) having a resolution of 1920 by 1080 pixels and a refresh rate of 480 Hz. At least these two identified frame rate and resolution modes 174 and 176 may be used for and during the execution of certain types of software applications. For example, a user may engage in online or offline gaming that may perform better with more resolution or higher frame rates. For example, a user may engage in a first-person shooter (FPS) gaming applications such as Counter-Strike®, Overwatch®, and Overwatch 2® that requires a high frame rate in order to engage with multiple opponents (bots or real online users) on screen in an effective way. A higher frame rate may be more important to a user when the user engages in a multiplayer team first-person shooter gaming application where the team relies on the user's cooperation to achieve those goals. Alternatively, some gaming applications such as AAA title gaming applications that advanced graphics and expansive gameplay to immerse the user in the gaming experience. Example AAA title gaming software applications may include, for example, Red Dead Redemption® series of gaming application, and The Witcher series gaming applications. With these AAA title gaming software applications, a higher resolution among available frame rate and resolution modes may be selected to present these advanced graphics and expansive gaming software applications.

Thus, a user may switch between the two or more different frame rate and resolution modes described herein to accommodate for specific types of image and video that will be presented on the video display device 150 during execution of the software application such as the various types of gaming applications described herein. For example, the user may use the higher resolution and lower refresh rate of the first frame rate and resolution mode 174 during execution of software applications that are not as dependent on a smooth motion in images or video such as AAA title gaming applications or other certain types of software applications requiring high resolution for detail. However, the user may also want the higher refresh rate, but lower resolution, of the second frame rate and resolution mode 176 when executing other types of applications such as the FPS software gaming applications that would present a smoother motion in video presented on the display 178 of the video display device 150 such as other gaming applications, video playing software applications with fast motion, and the like. The benefit of using the second frame rate and resolution mode 176 may be especially beneficial to a user executing a first-person shooter gaming application where smoother motion within the presented virtual gaming world.

In an embodiment, the image and video scaler hardware controller 164 includes a mode switch judgment firmware module 168 that may detect a change in signal timing from received incoming video data when a user selects a different frame rate and resolution mode 174 or 176 at an information handling system 100 with active, ongoing execution of code instructions 118 of a software application, such as a gaming application. The mode switch judgment firmware module 168 may be any firmware of the image and video scaler hardware controller 164 that may, when executed by the image and video scalar hardware controller 164, dynamically select between the first frame rate and resolution mode 174 and the second frame rate and resolution mode 176 based on a detected change of the signal timing of video data from GPU 106 or other hardware processor for the information handling system 100, a detected resolution of the video data, and a detected frame rate of the video data. The mode switch judgment firmware module 168 may then determine the detected resolution and frame rate relating to the bandwidth of the incoming video and image data.

For example, if a change in signal timing is detected, and the resolution of the incoming video and image data from the information handling system 100 exceeds or falls below a certain low threshold level (e.g., above a resolution higher than FHD or less than or equal to a FHD), the execution of the computer-readable program code instructions of the mode switch judgment firmware module 168 may then determine a frame rate of the incoming video and image data (e.g., frame rate greater than 240 Hz). Depending on the detected resolution and frame rate, the mode switch judgment firmware module 168 will switch from the first frame rate and resolution mode 174 (e.g., UHD at 240 Hz) or other frame rate and resolution mode (not shown) to the second frame rate and resolution mode 176 (e.g., FHD at 480 Hz) or vice-versa.

By way of example, where the resolution is higher than FHD resolutions, the execution of the mode switch judgment firmware module 168 by the image and video scalar hardware controller 164 may place the video display device 150 in a first resolution mode such as a UHD 240 Hz resolution mode. Where, however, the mode switch judgment firmware module 168 determines that the current detected resolution is at or below an FHD resolution, the mode switch judgment firmware module 168 may then determine if the frame rate is higher than 240 Hz. In this example embodiment, where the frame rate is not higher than 240 Hz, the mode switch judgment firmware module 168 keeps the video display device 150 in the first resolution mode (e.g., UHD). Where the frame rate is higher than 240 Hz and the resolution is at or below FHD resolution, however, the execution of the computer-readable program code instructions of the mode switch judgment firmware module 168 causes the video display device 150 to be placed in a second resolution mode such as a FHD 480 Hz resolution mode. It is appreciated that any resolution threshold or frame rate threshold may be set for the mode switch judgment firmware module 168 to toggle between a first resolution mode to a second resolution mode. The present specification also contemplates that the video display device 150 may comprise more than two different resolution modes and, in this example embodiment, additional resolution and frame rate thresholds may be set such that the image and video scalar hardware controller 164 may, on-the-fly, accommodate for changing detected resolutions and frame rates output from the information handling system and received at the video display device 150.

During execution of the mode switch judgment firmware module 168 by the image and video scaler hardware controller 164, a signal timing detector may monitor incoming video data received at the video display device 150 from the GPU 106 or other hardware processor. If a video data signal timing change is detected, the execution of code instructions of the mode switch judgment firmware module 168 by the image and video scaler hardware controller 164 may commence to determine resolution and frame rate levels of the incoming video data. For example, the resolution change may be detected by the signal timing detector measuring the total number of pixels per line and lines per frame by counting intervals between sync pulses in the video data. Thus, in an embodiment, the resolution may equal a rate at which individual pixels are transmitted in the video feed (e.g., via use of a pixel clock) divided by the product of the horizontal sync (e.g., individual lines) and the vertical sync (frames). In an embodiment, the frame rate may be derived from the frequency of the vertical sync pulses. Thus, in an embodiment, if the vertical sync pulses occur 60 times per second, the detected frame rate is 60 Hz. A running count of these vertical sync intervals, over time, may be detected by the mode switch judgment firmware module 168 in order to compute the frame rate and determine if that frame rate has changed. It is appreciated that, during execution of the mode switch judgment firmware module 168 by the image and video scaler hardware controller 164, a data storage device such as the non-volatile extended display identification data (EDID) memory 166 may be accessed by the mode switch judgment firmware module 168 in order to identify specific supported display mode timings set for operation at the video display device 150 and the software applications executing at the information handling system 100 via a current extended display identification data (EDID) record.

In embodiments of the present disclosure, the non-volatile EDID memory 166 may define a single plural mode EDID record that includes the current plurality of supported display mode timings and resolutions available such that compatibility with software applications using various resolutions, frame rates or other metrics (e.g., bandwidth) of video data received from executing from graphic processing units 106 or other hardware processors is ensured. In an embodiment, the structure of the non-volatile EDID memory 166 would contain the plural mode EDID record having all timing information for both the first frame rate and resolution mode 174 (e.g., an ultra-high definition (UHD) having a resolution of 3840 by 2160 pixels and a refresh rate of 240 Hz) and the second frame rate and resolution mode 176 (e.g., full high definition (FHD) having a resolution of 1920 by 1080 pixels and a refresh rate of 480 Hz) described herein. It is also appreciated that more than two different frame rate and resolution modes may also be defined within this plural mode EDID record stored in the non-volatile EDID memory 166 and the mode switch judgment firmware module 168 may also determine which of these additional frame rate and resolution modes would be appropriate for the detected video and image data signal rates, resolutions, and frame rates received from the GPU 106 of the information handling system 100. The non-volatile EDID memory 166 at the video display device 150 accessed by image and video scaler hardware controller 164 may be a flash memory in an example embodiment.

After determining which of the first frame rate and resolution mode, the second frame rate and resolution mode, or other frame rate and resolution mode is appropriate for the video data resolutions and frame rates detected, the image and video scaler hardware controller 164 may send the appropriate timing, resolution, and refresh rate data to a timing controller (TCON) 172 on the TCON panel 170 based on the appropriate frame rate and resolution mode selected from the plural EDID record. The TCON 172 may be any hardware controller that manages the timing and synchronization of signals that drive the display 178 of display panel 170. The operation of the TCON 172 may also calculate and manage the resolutions and frame rates for data transfer based on the detected resolution, refresh rate, color depth, and other factors described herein. In an example embodiment, the appropriate timing, resolution, and refresh rate data defined by the plural mode EDID record in the non-volatile EDID memory 166 may determine for the image and video scaler hardware controller 168 the appropriate frame rate and resolution mode 174 or 176 to switch to by the TCON 170. For example, a switch may be required on-the-fly at the video display device 150 from the first frame rate and resolution mode 174 to the second frame rate and resolution mode 176 or visa versa. As the switch is made, the TCON 172 may transmit the display data to the display 178 to present the output to the user of the information handling system 100 using the appropriate the first frame rate and resolution mode 174, the second frame rate and resolution mode 176, or other frame rate and resolution mode in various embodiments herein.

In an embodiment, the TCON 172 may mute the video prior to switching from the first frame rate and resolution mode 174 to the second frame rate and resolution mode 174 and unmute the video after the TCON 170 switches from the first frame rate and resolution mode 174 the second frame rate and resolution mode 176. During operation, the TCON 170 may calculate a frame rate and resolution for the second frame rate and resolution mode 176 based on the resizing and adjustments of the resolution and frame rate found in another mode from the plural mode EDID 166, and provide the image and video output to a display 178 of the video display device 150 at the resized and adjusted resolution. The image and video output to the display 178 of the video display device 150 is resized and has adjusted resolution according to the second frame rate and resolution mode 176 from the plural mode EDID 166 without distortion, with reduced delay, and without interrupting the ongoing execution of the software application such as the gaming application in embodiments herein. However, with the plural mode EDID stored at the non-volatile EDID memory 166 on the video display device 150, the video display device need not retrieve and coordinate a new EDID between the non-volatile EDID memory 166 on the video display device 150 and the software application executing on the information handling system 100. This saves steps of processing and such as invoking hot plug detection at the video display device 150 and rereading the EDID, re-managing high-bandwidth digital content protection (HDCP) authorization authentication, and generating new output timing for a link rate at information handling system 100.

Thus, the execution of the mode switch judgment firmware module 168 at the image and video video scaler hardware controller 164 and access to the plural mode EDID record at the non-volatile EDID memory 166 by the mode switch judgment firmware module 168 allows for the video display device 150 to forego such a plurality of extra processes and potential distortions that would be required or occur during switching between the first frame rate and resolution mode 174 and the second frame rate and resolution mode 176, on-the-fly, during execution of a software application that accesses an EDID only once during an execution duration. Thus, negative effects such as delay of blank screens and video distortion described herein may be reduced or eliminated when an on-the-fly selection to switch resolution and frame rate of a video graphics display 150 during ongoing execution of a software application such as a gaming application is conducted. Indeed, unlike other mode switching processes, the present system and method does not require a hot-plug detection (HPD) process, a link rate training process, and high-bandwidth digital content protection (HDCP) authorization that would lengthen the process of switching between a first frame rate and resolution mode 174 and a second frame rate and resolution mode 176. Such processes are involved when re-setting the EDID record used by both the information handling system 100 and software applications thereon in coordination with an image and video scaler hardware controller 164 at the video display device 150. Still further, instructions at the information handling system 100 to switch from the first frame rate and resolution mode 174 and the second frame rate and resolution mode 176 may be done during execution of software applications, such as gaming applications, without the user having to stop execution of the gaming application, switching frame rate and resolution modes, and then re-executing the gaming application in order to above the image distortion as described herein. Indeed, the user may access a display setting at the information handling system 100 such as at an operating system (OS) 122 or even a display setting at the executed gaming application in order to cause the switch at the information handling system 100 and the GPU 106 to automatically trigger a switch between the first frame rate and resolution mode 174 and second frame rate and resolution mode 176 at the video display device 150 according to embodiments herein. This allows the user to, for example, determine if the current refresh rate at the display 178 for the calculated incoming video data resolutions and frame rates during execution of the gaming application is sufficient, and change the frame rate and resolution on-the-fly with a shortened delay in game play and no lingering distortion in various embodiments herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

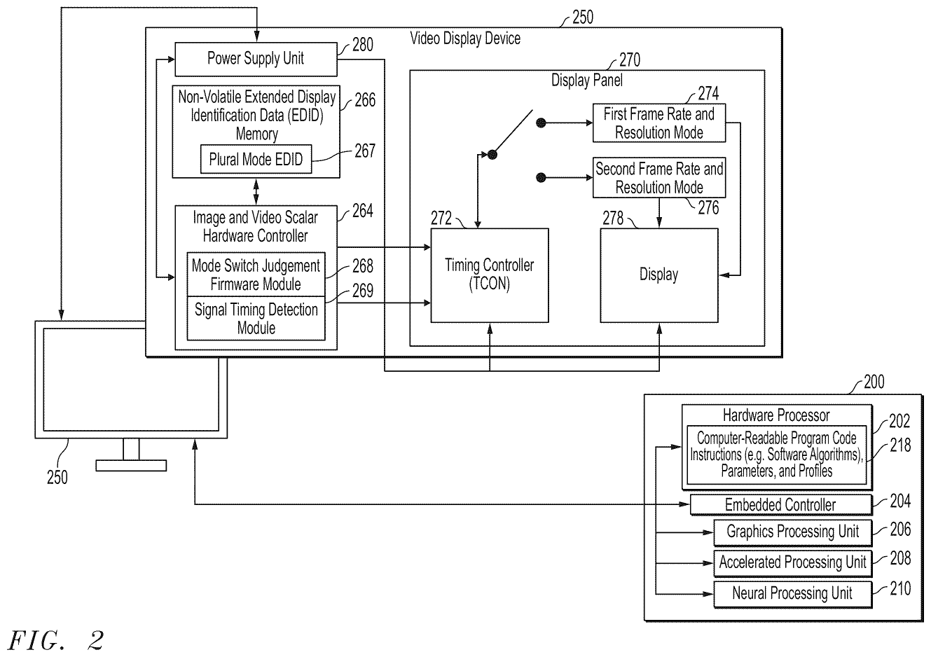

FIG. 2 is a graphic and block illustrating an information handling system 200 operatively coupled to a video display device 250 including an image and video scaler hardware controller 264 to execute computer-readable program code instructions of a mode switch judgment firmware module 268 to switch, on the-fly, from a first frame rate and resolution mode 274 to a second frame rate and resolution mode 276 according to another embodiment of the present disclosure. As described in some embodiments herein, the information handling system 200 in FIG. 2 is shown as operatively coupled to a standalone video display device 250. The video display device 250 to provide output to the user. The information handling system may also be a laptop information handling system with an integrated video display device as well as a keyboard and a touchpad in some embodiments. The information handling system 200 may have several input/output devices for the user to provide input to the information handling system 200. The information handling system 200 may be operationally coupled to one or more external input/output devices (e.g., 148, FIG. 1) such as an external video display device 250 and the present specification contemplates that the video display device 250 may be a built-in video display device 250 or a wired or wireless external video display device 250. It is appreciated that other types of information handling systems may be used and the information handling system 200 presented in FIG. 2 is presented as an example of an information handling system 200 that can be used with the systems and methods described herein.

As described herein, the video display device 250 may be powered via a PMU within the information handling system 200 via a power/data cable operatively coupling the information handling system 200 to the video display device 250. Alternatively, where the video display device 250 is a wireless video display device 250, the video display device 250 may be powered using a power cable operatively coupling an A/C power source to a PSU 280 within the video display device 250. The PSU 280 may operate similarly to the PMU described in connection with the information handling system 200 by regulating power from the A/C power source to each of the components of the video display device 250 such as the image and video scaler hardware controller 264, the TCON 272, and the display 278.

As described herein, the information handling system 200 includes a GPU (not shown) formed on a graphics card (not shown) that transmits image, video, and GUI data to the image and video scaler hardware controller 264 of the video display device 250. The GPU may be any hardware processing device that accelerates graphics rendering tasks such as rendering images, videos, and animations via an image and video scaler hardware controller 264 for representation on the display 278 of the video display device 250 as described herein.

As described herein, the video display device 250 includes an image and video scaler hardware controller 264 that receives the image and video data output from the graphics card and GPU of the information handling system 200. In an embodiment, the video display device 250 may be capable of presenting images and video at, at least, two different frame rate and resolution modes. For purposes of explanation, in an example embodiment, a first frame rate and resolution mode 274 may be a UHD mode having a resolution of 3840 by 2160 pixels and a refresh rate of 240 hertz (Hz). In this explanatory embodiment, the second frame rate and resolution mode 276 may be an FHD having a resolution of 1920 by 1080 pixels and a refresh rate of 480 Hz. As described herein, it is appreciated that more than these two frame rate and resolution modes may be available at the video display device 250 and the present specification contemplates that use of a plurality of other frame rates and resolution modes in the systems and methods described herein. It is appreciated that the two different resolution and frame rate modes described in the example embodiments herein may trade off refresh rates for resolutions that may provide acceptable resolutions and refresh rate outputs at the display 278 for the user such that the user may customize output at the video display device 250 based on currently-executed computer-readable program code instructions of a variety of different software applications (e.g., gaming software applications, word processing software applications, spreadsheet software applications, presentation software applications, video playback software applications, and the like).

During operation, a user may switch between these two different frame rate and resolution modes described in the example embodiments herein, or among a plurality of frame rate and resolution modes in other embodiments, to accommodate for various specific types of image and video that will be presented on the video display device 250 during execution of the ongoing software application such as various types of gaming applications. In an embodiment, this is done without the video display device 250 having to coordinate an updated EDID with the information handling system 200. Such a coordination of updating EDID between the video display device 250 and the information handling system 200 may otherwise be blocked by the executing software application when the executing software application is limited to checking the EDID at commencement of execution. This may occur, for example, with gaming applications which may be designed to minimize extraneous execution of instructions, such as a periodic checking of EDID utilized, on the CPU or GPU during execution of the gaming application in embodiments.

The user may, in an example embodiment, change these video and image settings at a “display settings” GUI associated with the OS of the information handling system 200. A user may switch the specific resolutions and refresh rates at this OS-level GUI that may accommodate, for example, a higher refresh rate during execution of a gaming software application (e.g., FPS gaming application) to increase the smoothness of the video output, such as for motion, at the display 278 or accommodate a higher resolution to increase visual immersion into, for example, details of a gaming experience (e.g., open world gaming applications). Alternatively, the user may change the video and image settings at a “gaming settings” GUI or other “application settings” GUI using an interface presented in an executed software application such as the gaming application (e.g., an FPS gaming application or open world gaming application). Whichever method the user implements in order to change these resolution and refresh rate settings by selecting a specific resolution and refresh rate mode, the GPU may receive this input from the user and send the video data (e.g., streaming data) to the image and video scaler hardware controller 264 at a signal timing based on the selected setting requirements.

During execution of a software application, the user may want a higher refresh rate than that which is currently being presented to the user at the display 278. In the example where the user is executing a gaming software application at the information handling system 200, the user may see a level of motion blur in the video, stuttering or choppiness in the images, screen tearing where sequential frames are displayed at the same time, and reduced immersion and visual fluidity, among other visual artifacts when the motion of the gaming is fast pace. A higher refresh rate, even at a lower resolution, may resolve these issues. As such, the user may access the application settings and change this refresh rate such as one associated with the second frame rate and resolution mode 276 which, in this example embodiment, includes a higher refresh rate but a lower resolution.

As such, the image and video scaler hardware controller 264 includes a mode switch judgment firmware module 268 that receives the image and video data output from the information handling system 200 and, with a signal timing detection module 269, detects a change in the timing signal of the video data received according to the newly selected faster refresh rate with lower resolution. The mode switch judgment firmware module 268 includes firmware executing at the image and video scaler hardware controller 264 that may execute computer-readable program code of a signal timing detection module 269 to detect a timing signal of the incoming video data from the information handling system 200. This is done to determine that a change in the video data signal timing is sufficiently different, exceeds one or more resolution and frame rate thresholds, such that it indicates that a user has changed the frame rate and resolution mode at the OS or the ongoing software application at the information handling system 200. Then the mode switch judgment firmware module 268 includes firmware executing at the image and video scaler hardware controller 264 to dynamically access a plural mode EDID 267 at the non-volatile EDID memory at the video display device to select between the first frame rate and resolution mode 274 and the second frame rate and resolution mode 276 meeting or exceeding one or more resolution and frame rate thresholds to indicate which mode is appropriate.

For example, a decision is made as to whether the resolutions and frame rates of the incoming video and image data from the information handling system 200 exceeds an upper resolution threshold, has not changed, or has met or fallen below any other lower resolution threshold. In another example, the mode switch judgment firmware module 268 executing the signal timing detection module 269 may detect that the detected frame rate exceeds an upper frame rate threshold (e.g., 240 Hz). These two determinations may be used by the image and video scalar hardware controller 264 to determine whether to switch from the second frame rate and resolution mode to the first frame rate and resolution mode or vice versa. By way of example, where the resolution is not higher than FHD resolutions, the execution of the mode switch judgment firmware module 268 by the image and video scalar hardware controller 264 may place the video display device 250 in a first resolution mode such as a UHD 240 Hz resolution mode. Where, however, the mode switch judgment firmware module 268 determines that the current detected resolution is higher than an FHD resolution, the mode switch judgment firmware module 268 may then determine if the frame rate is higher than 240 Hz. In this example embodiment, where the frame rate is not higher than 240 Hz, the mode switch judgment firmware module 268 keeps the video display device 250 in the first resolution mode (e.g., UHD). Where the frame rate is higher than 240 Hz, however, the execution of the computer-readable program code instructions of the mode switch judgment firmware module 268 causes the video display device 250 to be placed in a second resolution mode such as a FHD 80 Hz resolution mode. It is appreciated that any resolution threshold or frame rate threshold may be set for the mode switch judgment firmware module 268 to toggle between a first resolution mode to a second resolution mode. The present specification also contemplates that the video display device 250 may comprise more than two different resolution modes and, in this example embodiment, additional resolution and frame rate thresholds may be set such that the image and video scalar hardware controller 264 may, on-the-fly, accommodate for changing detected resolutions and frame rates output from the information handling system and received at the video display device 250.

In order to gather data and settings necessary to signal to the TCON 272 to switch from the first frame rate and resolution mode 274 to the second frame rate and resolution mode 276, the mode switch judgment firmware module 268 of the image and video scaler hardware controller 264 may access the non-volatile EDID memory 266. In an embodiment, the non-volatile EDID memory 266 may include a single plural mode EDID record 267 that describes the current plurality of supported display mode timings such that compatibility with software applications using resolutions, frame rates or other metrics (e.g., bandwidth) executing from processing units 206 or other hardware processors is ensured. Detecting the changes in video data signal timing and determining bandwidth from video data received from the information handling system 200 processing units 206 may be detected by the mode switch judgment firmware module 268 executing at the image and video scaler hardware controller 264 at the video display device 250 to automatically change between plural frame rate and resolution modes. In an embodiment, the structure of the non-volatile EDID memory 266 would contain the plural mode EDID record 267 having all timing information and settings for both the first frame rate and resolution mode 274 and the second frame rate and resolution mode 276 available on the video display device 250 described herein. It is also appreciated that more than two different frame rate and resolution modes may also be defined within this plural mode EDID record 267 stored in the non-volatile EDID memory 266 and the mode switch judgment firmware module 268 may also determine which, if any, of these additional frame rate and resolution modes would be appropriate for the detected video and image data signal rates and bandwidth received from the GPU of the information handling system 200. The non-volatile EDID memory 266 at the video display device 250 accessed by image and video scaler hardware controller 264 may be a flash memory in an example embodiment.

Therefore, after detecting a change in the timing signal of the video and image data received from the information handling system 200, the mode switch judgment firmware module 268 of the image and video scaler hardware controller 264 may determine, based on detected change of the signal timing of video data from GPU 206 or other hardware processor for the information handling system 200, the received resolutions and frame rates resulting from the user selection and select among the plural modes on the plural mode EDID 267 that defines settings for the first frame rate and resolution mode 274, the second frame rate and resolution mode 276, or other frame rate and resolution mode as selected. The mode switch judgment firmware module 268 determines the resolutions and frame rates of the incoming video and image data. Where no change in signal timing is detected, the mode switch judgment firmware module 268 may determine that no change in the frame rate and resolution mode is necessary and the image and video scaler hardware controller 264 may transmit the video data onto the TCON 272 on the TCON panel 270 to manage the timing and synchronization of signals that drive the display 278 according to the current frame rate and resolution mode as described herein. However, where the mode switch judgment firmware module 268 has detected a change in the signal timing of the video and image data from the information handling system 200, and has detected the current resolutions and frame rates of that video and image data, the execution of the firmware of the mode switch judgment firmware module 268 accesses the EDID and determines which frame rate and resolution mode settings are to be presented at the TCON 272 along with the selected new mode signal (e.g., either the first frame rate and resolution mode 274 or the second frame rate and resolution mode 276). Then the TCON 272 may present that incoming video data on the display 278 of the display panel 270 according to the newly identified frame rate and resolution mode settings determined from the plural mode EDID 267.

The TCON 272, having received the mode selected signal along with the updated video data then selects the appropriate frame rate and resolution mode to change from the first frame rate and resolution mode 274 to the second frame rate and resolution mode 276 or visa versa pursuant to the user-requested changes at the information handling system 200. As described herein, the TCON 272 may calculate and manage the bandwidth, resolutions, and frame rates for data transfer to the display 278 based on the resolution, refresh rate, color depth, and other factors associated with each of the first frame rate and resolution mode 274 and second frame rate and resolution mode 276 so that the user may receive output at the display 278 commensurate with the selected changes to the settings at the information handling system 200. In an example embodiment, the appropriate timing, resolution, and refresh rate data defined by the plural mode EDID record 267 in the non-volatile EDID memory 266 may determine for the image and video scaler hardware controller 268 the appropriate frame rate and resolution mode 274 or 276 to switch to by the TCON 270 for display of the video data. For example, a switch may be required on-the-fly at the video display device 250 from the first frame rate and resolution mode 274 to the second frame rate and resolution mode 276 or visa versa. The TCON 272 may transmit the video data to the display 278 to present the output to the user of the information handling system 200 based on the on-the-fly switch of frame rate or resolution by using the appropriate the first frame rate and resolution mode 274, the second frame rate and resolution mode 276, or other frame rate and resolution mode that is selected from the plural mode EDID 267 in various embodiments herein.

Again, in some embodiments described herein, the TCON 272 may mute the video prior to switching from the first frame rate and resolution mode 274 to the second frame rate and resolution mode 276 and unmute the video after the TCON 272 switches from the first frame rate and resolution mode 274 the second frame rate and resolution mode 276. Similarly, switching from the second frame rate and resolution mode 276 to the first frame rate and resolution mode 274 may involve a similar muting of the video temporarily as the switch is made. During operation, the TCON 272 may calculate a frame rate and resolution for the second frame rate and resolution mode 276 based on the resizing and adjustments of the resolution and frame rate found in another mode from the plural mode EDID 267 from the non-volatile EDID memory at the video display device 250. This muting of the video display may be reduced due to the on-board plural mode EDID 267 accessed by the image and video scaler hardware controller 264 and TCON 272 and preventing a need to correlate EDID with the software application executing at the information handling system 200. The TCON may then provide the image and video output to a display 278 of the video display device 250 at the resized and adjusted resolution pursuant to the switch being made on-board the video display device 250 by the image and video scaler hardware controller 264 and TCON 272. The image and video output to the display 278 of the video display device 250 is resized and has adjusted resolution according to the second frame rate and resolution mode 276 from the first frame rate and resolution mode 274 or vice-versa as determined from the plural mode EDID 267, for example, without distortion, with reduced delay, and without interrupting the ongoing execution of the software application such as the gaming application in embodiments herein.

As described herein, the systems and methods described herein includes an image and video scaler hardware controller 264 with its mode switch judgment firmware module 268 that determines an appropriate display mode based on the input signal resolution and frame rate detected thereby providing a dynamic and responsive method for frame rate and resolution mode switching. This allows the video display device 250 to adapt, in real-time, to different content and frame rates without requiring a HPD event being conducted. By not conducting the HPD event, the time required to switch from the first frame rate and resolution mode 274 to the second frame rate and resolution mode 276, or visa versa, is significantly reduced. Additionally, by combining all supported display modes within the plural mode EDID record 267 stored in the non-volatile EDID memory 266, the systems and methods further eliminate the need for separate correlating the EDID stored in the non-volatile EDID memory 266 devices and used at the information handling system during software application execution for each distinct frame rate and resolution mode available at the video display device 250. This also reduces the complexity and potential issues related to the EDID being switched such as video distortions and long mode switch timing. It is appreciated that the systems and methods described herein may be executed on behalf of each of the video display devices 250 operatively coupled to the information handling system 200 such that the user may use any device settings to manage frame rate and resolution mode changes at each video display device 250.

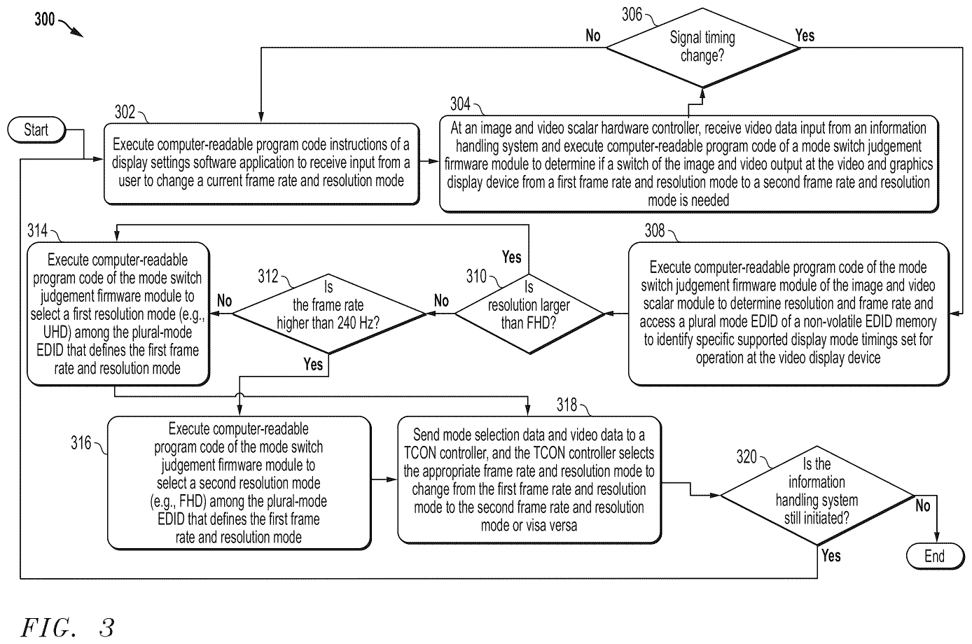

FIG. 3 is a flow diagram showing a method 300 executing computer-readable program code instructions for switching resolution modes within a dual resolution video display device according to an embodiment of the present disclosure. Although this method 300 describes a dual resolution video and graphic display device, it is appreciated that the video display device may include more than two different frame rate and resolution modes between which the user may select to perform the methods described herein resulting in the display of image and videos at the video display device at the appropriate resolution and frame rate. Additionally, the method 300 described in connection with FIG. 3 may be operated on an information handling system such as an information handling system (e.g., 100, 200) described in connection with FIG. 1 or 2.

The method 300 includes, at block 302, executing computer-readable program code instructions of a display settings for an executing software application or an operating system (OS) to receive input from a user to change a current frame rate and resolution mode during ongoing execution of the software application. In an embodiment, the display settings for the software application may include an OS-level display setting interface that allows user to select among a plurality of available and supported frame rate and resolution modes at each of one or more video display devices operatively coupled to the information handling system. The user may also be allowed to execute a software application such as a gaming application that includes display settings adjustment interfaces that, when accessed, provide a user interface for the user to select among a plurality of frame rate and resolution modes that include disparate frame rates and resolutions such as the UHD and FHD frame rates and resolutions described herein. Therefore, in an embodiment, the user may be executing computer-readable program code instructions of a software application such as a gaming software application and may access a display settings software application to change the frame rate and resolution mode while the game or other software application is ongoing and generating video data for display as described herein.

At block 304, the method 300 further includes, at an image and video scaler hardware controller, receiving video data input from an information handling system that may have a signal timing change to indicate a switch of the image and video output at the video display device from a first frame rate and resolution mode to a second frame rate and resolution mode or vice versa is needed. As described herein, the image and video scaler hardware controller may be any hardware device that is used to adjust the resolution of image and video signals from received video data from a GPU or other processor at an information handling system by scaling them up or down to match, in the present specification, one of a plurality of available native resolutions and frame rates available at the or each of a plurality of operatively coupled video display devices. In an embodiment, the image and video scaler hardware controller may determine if switching from the first frame rate and resolution mode to the second frame rate and resolution mode or vice versa is to occur by identifying whether a change in signal timing from the video input data from the information handling system is present at the display device.

Therefore, at block 304, the method may include the mode and switch judgement firmware module of the image and video scaler hardware controller executing a signal timing detection process to identify whether a change in the timing signal has occurred in the received video data. As described herein, the mode switch judgment firmware module includes firmware of the image and video scaler hardware controller that may be capable of dynamically selecting between the first frame rate and resolution mode and the second frame rate and resolution mode based on detected resolutions and frame rates of the received video data. The signal timing detection process at the image and video scaler hardware controller may determine changes in the signal timing of the video input data detected from the GPU or other processors above a threshold level. In the video data stream transmitted from an information handling system to the video display device, the mode switch judgment firmware module of the image and video scaler hardware controller may detect mode changes from the information handling system and ongoing software application execution by continuously monitoring the signal timing at the signal and timing detection as well as other characteristics of the incoming video data. For example, a specific, regularly occurring signal embedded within the video data received from the information handling system operates as a reference point for accurately determining any change in signal timing of each frame received in the video data from the GPU or other hardware processor. This may dictate the pace at which the video should be displayed and which, along with resolution of the video data received for each frame, is directly related to bandwidth because the frequency of this timing signal can indicate the potential data rate and data volume of the video stream. For example, the resolution change may be detected by the signal timing detector measuring the total number of pixels per line and lines per frame by counting intervals between sync pulses in the video data. Thus, in an embodiment, the resolution may equal a rate at which individual pixels are transmitted in the video feed (e.g., via use of a pixel clock) divided by the product of the horizontal sync (e.g., individual lines) and the vertical sync (frames). In an embodiment, the frame rate may be derived from the frequency of the vertical sync pulses. Thus, in an embodiment, if the vertical sync pulses occur 60 times per second, the detected frame rate is 60 Hz. A running count of these vertical sync intervals, over time, may be detected by the mode switch judgment firmware module in order to compute the frame rate and determine if that frame rate has changed. In an embodiment, faster occurring timing signals often correspond to higher bandwidth requirements and resolutions and frame rates due to the need to transmit more data per second to maintain smooth playback at a specific frame rate and resolution mode. It is this detected video data signal timing above or below one or more thresholds of change in the video data signal timing that is detected by the mode switch judgement firmware module and that may be used to determine if a frame rate and resolution mode has been switched at the information handling system.

Therefore, at block 306, for example, a decision is made as to whether the threshold level of signal timing change of the incoming video and image data from the information handling system is exceeded. For example, the mode switch judgment firmware module may detect that the signal timing has changed and determine that an automatic switch from the first or second frame rate and resolution mode to the other frame rate and resolution mode is warranted at the video display device. In another embodiment, where the detected signal timing remains unchanged or within the signal timing change threshold, the execution of the mode switch judgment firmware module by the image and video scaler hardware controller will detect that the signal timing has been maintained and the frame rate and resolution mode currently in effect will be maintained. In other words, no frame rate and resolution mode has changed at the information handling system during execution of the gaming or other software applications and an automatic frame rate and resolution mode change at the video display device is not needed.

Where at block 306, the signal timing change is not above a threshold level and an automatic frame rate and resolution mode change at the video display device is not needed, the method may return to block 302 for continued execution of the ongoing gaming or other software application and monitoring for additional changes in signal timing. Where at block 306, the signal timing change is above a threshold level and an automatic frame rate and resolution mode change at the video display device is needed, the method 300 may proceed to block 308.

At block 308, the method 300 includes executing computer-readable program code instructions of the mode switch judgment firmware module of the image and video scaler hardware controller to determine a resolution and frame rate of streaming image and video data from the information handling system and access the plural mode EDID stored at a non-volatile EDID memory. In an embodiment, the non-volatile EDID memory may include a plural mode EDID record that describes a current plurality of supported display mode timings such that compatibility with software applications using various resolutions, frame rates or other metrics executing from graphic processing units or other hardware processors is ensured during any changes executing during ongoing execution of that software application at the information handling system. In an embodiment, a non-volatile EDID memory at the video display device would contain the plural mode EDID record having timing information and settings for both the first frame rate and resolution mode and the second frame rate and resolution mode described herein as well as other frame rate and resolution modes that may also be defined within this non-volatile EDID memory. It is also appreciated that more than two different frame rate and resolution modes may also be defined within this plural mode EDID record stored in the non-volatile EDID memory and the mode switch judgment firmware module may also determine which of these additional frame rate and resolution modes would be appropriate for the detected video and image data signal rates and bandwidth received from the GPU of the information handling system. The non-volatile EDID memory at the video display device accessed by image and video scaler hardware controller may be a flash memory in an example embodiment.

Concurrently, the switch judgment firmware module may, at block 310, determine if the detected resolution identified or determined is larger than an FHD resolution level. This determination is made such that the incoming video data input received at the video display device does not have a resolution requirement such that an FHD mode may not accommodate this resolution. As described herein, after the switch judgment firmware module has detected that the signal timing has changed and that the detected resolution is, in fact, larger than an FHD resolution level, the process may proceed to block 314. When the switch judgment firmware module has detected that the signal timing has changed and that the detected resolution is at or below an FHD resolution level such that FHD mode may accommodate it, the process may proceed to block 312.

At block 314, the image and video scalar hardware controller or another hardware processing resource at the video display device executes computer-readable program code of the mode switch judgment firmware module to select a first resolution mode among the plural-mode EDID that defines the first frame rate and resolution mode. In an example where the image and video scalar hardware controller was operating the video display device in the second frame rate and resolution mode, for example an FHD mode, this would require a switch to the first frame rate and resolution mode such as a UHD mode in an example embodiment. However, if the switch judgment firmware module determines that the image and video scalar hardware controller is operating the video display device at the first frame rate and resolution mode, for example already in a UHD mode, then no switch is necessary. The process then proceeds to block 318 to implement the selected or maintained frame rate and resolution mode, for example the UHD mode.

Returning block 310, when the detected resolution of the streaming image and video data from the information handling system is at or below an FHD resolution level that an FHD mode can accommodate, the method 300 continues to block 312. At block 312, a second determination is made as to where the detected frame rate of the incoming video data by the switch judgment firmware module is higher than 240 Hz. Where the detected frame rate is not higher than 240 Hz, the method 300 continues to block 314 to switch to the first frame rate and resolution mode, such as the UHD mode in an example embodiment, as described herein. However, where the detected frame rate is higher than 240 Hz, then the method 300 may continue to block 316. At block 316, similar to block 314, the image and video scalar hardware controller may execute computer-readable program code of the mode switch judgment firmware module to select a second resolution mode among the plural-mode EDID that defines the first frame rate and resolution mode. In an example embodiment, this second frame rate and resolution mode is an FHD mode. Again, in an example where the image and video scalar hardware controller was operating the video display device in the first frame rate and resolution mode, such as the UHD mode for example, this would require a switch to the second frame rate and resolution mode, for example the FHD mode. However, if the switch judgment firmware module determines that the image and video scalar hardware controller is operating the video display device at the second frame rate and resolution mode already, for example the FHD mode, then no switch is necessary at block 316.

After the appropriate resolution mode has been determined and selected by the switch judgment firmware module, the method 300 may continue to block 318. At block 318, the method 300 includes sending this mode selection data along with the video data to the TCON with the TCON selecting the appropriate frame rate and resolution mode to change from the first frame rate and resolution mode to the second frame rate and resolution mode or visa versa depending on the requested change from the user. As described herein, the TCON may manage the bandwidth for data transfer to the display based on the resolution, refresh rate, color depth, and other factors associated with each of the first frame rate and resolution mode and second frame rate and resolution mode so that the user may receive output at the display commensurate with the selected changes to the settings at the information handling system. In an example embodiment, the appropriate timing, resolution, and refresh rate data defined by the plural mode EDID record in the non-volatile EDID memory may determine for the image and video video scaler hardware controller the appropriate frame rate and resolution mode to switch to by the TCON. For example, a switch may be required on-the-fly at the video display device from the first frame rate and resolution mode to the second frame rate and resolution mode or vice versa. As the switch is made, the TCON may transmit the display data to the display to present the output at the display panel to the user of the information handling system using the appropriate the first frame rate and resolution mode, the second frame rate and resolution mode, or other frame rate and resolution mode in various embodiments herein.

In an embodiment, the TCON may mute the video prior to switching from the first frame rate and resolution mode to the second frame rate and resolution mode and unmute the video after the TCON switches from the first frame rate and resolution mode to the second frame rate and resolution mode. This muting may occur during switching between any two frame rate and resolution modes in embodiments herein. The delay of this muting is reduced with the access to the plural mode EDID record on-board at the video display device based on triggering from a change in video data signal timing received. During operation, the TCON may calculate a frame rate and resolution for the second frame rate and resolution mode based on the resizing and adjustments of the resolution and frame rate found in another mode from the plural mode EDID, and provide the image and video output to a display of the video display device at the resized and adjusted resolution. Re-coordination of the EDID and rate retraining steps between the information handling system and the video display device may be reduced. The image and video output to the display of the video display device is resized and has adjusted resolution according to the second frame rate and resolution mode from the plural mode EDID without distortion, with reduced delay and limited interruption to the ongoing execution of the software application such as the gaming application in embodiments herein.

At block 314, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A video display device comprising:
an image and video scaler hardware controller, a nonvolatile extended display identification data (EDID) storage device, a timing controller (TCON), a display panel, and a power supply unit (PSU) to provide power to the image and video scaler hardware controller, the nonvolatile EDID storage device, the TCON and the display panel;
the image and video scaler hardware controller to receive input video data from an information handling system;
the image and video scaler hardware controller to execute computer-readable program code of a mode switch judgment firmware module to detect an on-the-fly signal timing change of the video data during execution of a software application at the information handling system and determine a resolution and frame rate of the video data;
the image and video scaler hardware controller to execute the computer-readable program code of the mode switch judgment firmware module to access a plural mode EDID within the non-volatile EDID storage device having a first frame rate and resolution mode and a second frame rate and resolution mode; and
the TCON to execute to resize and adjust a resolution and frame rate of video output at the display panel from the first frame rate and resolution mode to the second frame rate and resolution mode.

2. The video display device of claim 1, wherein the first frame rate and resolution mode is an ultra-high definition (UHD) mode having a resolution of 1920 by 1080 pixels and a refresh rate of 480 Hz.

3. The video display device of claim 1, wherein the second frame rate and resolution mode is a full high definition (FHD) having a resolution of 3840 by 2160 pixels and a refresh rate of 240 Hz.

4. The video display device of claim 1, wherein the first frame rate and resolution mode has a lower resolution and higher refresh rate than the second frame rate and resolution mode.

5. The video display device of claim 1, wherein the first frame rate and resolution mode has a higher resolution and lower refresh rate than the second frame rate and resolution mode.

6. The video display device of claim 1 further comprising:
the image and video scaler hardware controller to detect a second on-the-fly signal timing change of the video data during execution of the software application at the information handling system and determine a second resolution and frame rate of the video data;
the image and video scaler hardware controller to execute the computer-readable program code of the mode switch judgment firmware module to access the plural mode EDID; and
the TCON to execute to resize and adjust the resolution and frame rate at the display panel from the second frame rate and resolution mode to the first frame rate and resolution mode.

7. The video display device of claim 1 further comprising:
the on-the-fly signal timing change of the video data during execution of the software application at the information handling system is triggered by user activation of an application setting during ongoing execution of the software application at the information handling system to switch image and video output at the video display device.

8. The video display device of claim 1 further comprising:
the on-the-fly signal timing change of the video data during execution of the software application at the information handling system is triggered by user activation of an operating system display setting during ongoing execution of the software application at the information handling system to switch image and video output at the video display device.

9. The video display device of claim 1 further comprising:
the image and video scaler hardware controller to execute the computer-readable program code instructions of the mode switch judgment firmware module to direct the TCON to switch from the first frame rate and resolution mode to the second frame rate and resolution mode pursuant to the plural mode EDID at the video display device.

10. A method executing computer-readable program code instructions for switching frame rate and resolution modes within a dual resolution video display device comprising:
receiving input video data, at an image and video scaler hardware controller, from an information handling system;
executing computer-readable program code, via an image and video scaler hardware controller, of a mode switch judgment firmware module to detect an on-the-fly signal timing change of the video data during execution of a software application at the information handling system and determine a resolution and frame rate of the video data;
executing the computer-readable program code, via the image and video scaler hardware controller, of the mode switch judgment firmware module to access a plural mode extended display identification data (EDID) within a non-volatile EDID storage device at the extended display identification data having a first frame rate and resolution mode and a second frame rate and resolution mode to select between the first frame rate and resolution mode and the second frame rate and resolution mode based on the determined resolution and frame rate of the video data after the on-the-fly signal timing change relative to a first bandwidth threshold for the first frame rate and resolution mode and a second resolution and frame rate threshold for the second frame rate and resolution mode; and
resizing and adjusting a resolution and frame rate of video output at a display panel, via execution of a timing controller (TCON) pursuant to instructions from the image and video scaler hardware controller, between the first frame rate and resolution mode and the second frame rate and resolution mode based on the determined resolution and frame rate of the video data after the on-the-fly signal timing change.

11. The method of claim 10, wherein the first frame rate and resolution mode has a lower resolution and higher refresh rate than the second frame rate and resolution mode.

12. The method of claim 10, wherein the on-the-fly signal timing change of the video data during execution of the software application at the information handling system is triggered by user activation of an application setting to switch image and video output at the video display device of the software application during ongoing execution of the software application that is a video gaming software application executing at the information handling system.

13. The method of claim 10 further comprising:
detecting a second on-the-fly signal timing change of the video data, via the image and video scaler hardware controller, to during execution of the software application at the information handling system and determining a second resolution and frame rate of the video data;
executing the computer-readable program code of the mode switch judgment firmware module to access the plural mode EDID; and
resizing and adjusting to a second resolution and frame rate at the display panel, via the TCON, between the first frame rate and resolution mode and the second frame rate and resolution mode based on the determined second resolution and frame rate of the video data after the second on-the-fly signal timing change relative to the first resolution and frame rate threshold for the first frame rate and resolution mode and the second resolution and frame rate threshold for the second frame rate and resolution mode.

14. The method of claim 10 further comprising:
muting the video output, via the TCON, prior to switching from the first frame rate and resolution mode to the second frame rate and resolution mode and unmuting the video output after the TCON switches from the first frame rate and resolution mode to the second frame rate and resolution mode.

15. The method of claim 10, wherein the first frame rate and resolution mode is an ultra-high definition (UHD) having a resolution of 1920 by 1080 pixels and a refresh rate of 480 Hz.

16. A video display device comprising:
an image and video scaler hardware controller, a nonvolatile extended display identification data (EDID) storage device, a timing controller (TCON), a display panel, and a power supply unit (PSU) to provide power to the image and video scaler hardware controller, the nonvolatile EDID storage device, the TCON and the display panel;
the image and video scaler hardware controller to receive input video data from an information handling system;
the image and video scaler hardware controller to execute computer-readable program code of a mode switch judgment firmware module to detect an on-the-fly signal timing change of the video data during execution of a software application at the information handling system and determine a resolution and frame rate of the video data;
the image and video scaler hardware controller to execute the computer-readable program code of the mode switch judgment firmware module to access a plural mode EDID within the non-volatile EDID storage device having a first frame rate and resolution mode and a second frame rate and resolution mode, where the first frame rate and resolution mode has a lower resolution and higher refresh rate than the second frame rate and resolution mode; and
the TCON to execute to resize and adjust a resolution and frame rate at the display panel between the first frame rate and resolution mode and the second frame rate and resolution mode based on the determined resolution and frame rate of the video data after the on-the-fly signal timing change relative to a first resolution and frame rate threshold for the first frame rate and resolution mode and a second resolution and frame rate threshold for the second frame rate and resolution mode.

17. The video display device of claim 16, wherein the first frame rate and resolution mode is an ultra-high definition (UHD) mode having a resolution of 1920 by 1080 pixels and a refresh rate of 480 Hz and the second frame rate and resolution mode is a full high definition (FHD) having a resolution of 3840 by 2160 pixels and a refresh rate of 240 Hz.

18. The video display device of claim 16 further comprising:
the image and video scaler hardware controller to detect a second on-the-fly signal timing change of the video data during execution of the software application at the information handling system and determine a second resolution and frame rate of the video data;
the image and video scaler hardware controller to execute the computer-readable program code of the mode switch judgment firmware module to access the plural mode EDID; and
the TCON to execute to resize and adjust to a second resolution and frame rate at the display panel between the first frame rate and resolution mode and the second frame rate and resolution mode based on the determined second resolution and frame rate of the video data after the second on-the-fly signal timing change relative to the first resolution and frame rate threshold for the first frame rate and resolution mode and the second resolution and frame rate threshold for the second frame rate and resolution mode.

19. The video display device of claim 16 further comprising:
the on-the-fly signal timing change of the video data during execution of the software application at the information handling system is triggered by user activation of an application setting of the software application to switch image and video output at the video display device during ongoing execution of the software application at the information handling system.

20. The video display device of claim 16 further comprising:
the image and video scaler hardware controller to execute the computer-readable program code of the mode switch judgment firmware module to access the plural mode EDID within the non-volatile EDID storage device having a plurality of frame rate and resolution modes, where the plurality of frame rate and resolution modes have a plurality of resolutions and refresh rates for the resolution and frame rate of video output at the display panel; and
the TCON to execute to resize and adjust the resolution and frame rate at the display panel by selection among the plurality of frame rate and resolution modes from the plural mode EDID based on the determined resolution and frame rate of the video data after the on-the-fly signal timing change relative to a plurality of resolution and frame rate thresholds for each of the plurality of frame rate and resolution modes.
